(19) United States
(12) Patent Application Publication
(10) Pub. No.: US 2007/0046439 A1
(43) Pub. Date: Mar. 1, 2007

(54) Radio frequency identification system with device for protecting privacy and method of operation

(76) Inventors: Yoshitsugu Takaku, Tokyo (JP); Tetsuo Tanemura, Yokohama (JP)

Correspondence Address: MOTOROLA INC, 600 NORTH US HIGHWAY 45, ROOM AS437, LIBERTYVILLE, IL, 60048-5343, US

(21) Appl. No.: 11/218,251

(22) Filed: Sep. 1, 2005

(51) Int. Cl. H04Q 5/22

(52) U.S. Cl. 340/10.41; 340/572.3; 340/10.52

(57) ABSTRACT

An RFID system (100) includes an RFID privacy protection device (126) that keeps track of RFID tags possessed by a user, senses nearby RFID scanners (110, 112, 124) and limits the communication between the nearby RFID scanners and the RFID tags to what is necessary to accomplish the function of the RFID system by selectively generating a masking signal.

### FIELD OF THE INVENTION

The present invention relates generally to Radio Frequency Identification (RFID) systems.

### BACKGROUND

Developments in the fields of wireless communication and integrated circuit manufacturing, have reduced the cost of RFID devices to the point that they can be used to track individual retail items (e.g., articles of clothing, cereal boxes). RFID tags for tracking retail items will render bar codes obsolete. RFID tags are superior to bar codes in that an RFID tag reader can read an RFID tag through obstructions (e.g., other items being purchased) and without the RFID tag having to be presented facing the RFID reader.

However, the anticipated ubiquity of RFID tags coupled with the flexibility of reading tags, which is such that a person possessing an RFID tag does not need to do anything for the RFID tag to be read, meaning that the RFID tag can be read without the person being aware of the reading of the tag has raised privacy protection concerns.

Privacy protection advocates have raised concerns that unscrupulous scanning of RFID tags will be used to track people's movements and determine what belongings people are carrying with them.

One proposal for limiting the potential for infringement on privacy, is to provide a means whereby an authorized party (e.g., cashier) permanently disables or ‘kills’ RFID tags when they pass into the hands of a consumer. The latter approach has the drawback that it forestalls post purchase consumer uses of RFID tags which are being contemplated.

Another proposal for preventing encroachment on privacy by illicit scanning of RFID tags on a person's possessions is to provide blocker tags that simulate the presence of a very large number of RFID tags and thereby overwhelm any reader that attempts to read RFID tags in its vicinity. Such blocker tags have the potential to be misused to defeat RFID based security systems.

It would be desirable to have a system, device and method that allow RFID technology to accomplish its intended purpose without facilitating encroachment on personal privacy.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of an RFID system in accordance with some embodiments of the invention;

FIG. 2 is a block diagram of a RFID privacy protection device in accordance with some embodiments of the invention;

FIG. 3 is a flowchart of a method of operating the privacy protection device shown in FIG. 2 in accordance with some embodiments of the invention;

FIG. 4 is a flowchart of a method of compiling a list of RFID item tags possessed by a user that is used in operating the privacy protection device according to the method shown in FIG. 3;

FIG. 5 is a flowchart of a method of operating an RFID reader that is used in the RFID system shown in FIG. 1 in accordance with some embodiments of the invention; and

FIG. 6 is a flowchart fragment showing one alternative to the method shown in FIG. 3;

FIG. 7 is a flowchart fragment showing another alternative to the method shown in FIG. 3; and

FIG. 8 is a flowchart showing a method of operating a RFID reader/writer of the RFID system shown in FIG. 1 that complements the flowchart fragment shown in FIG. 7.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to RFID privacy protection. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of an RFID privacy protection device described herein. The non-processor circuits may include, but are not limited to, a radio receiver, a radio transmitter, signal drivers, clock circuits, power source circuits, and user input devices. As such, these functions may be interpreted as steps of a method to achieve privacy protection in an RFID system. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

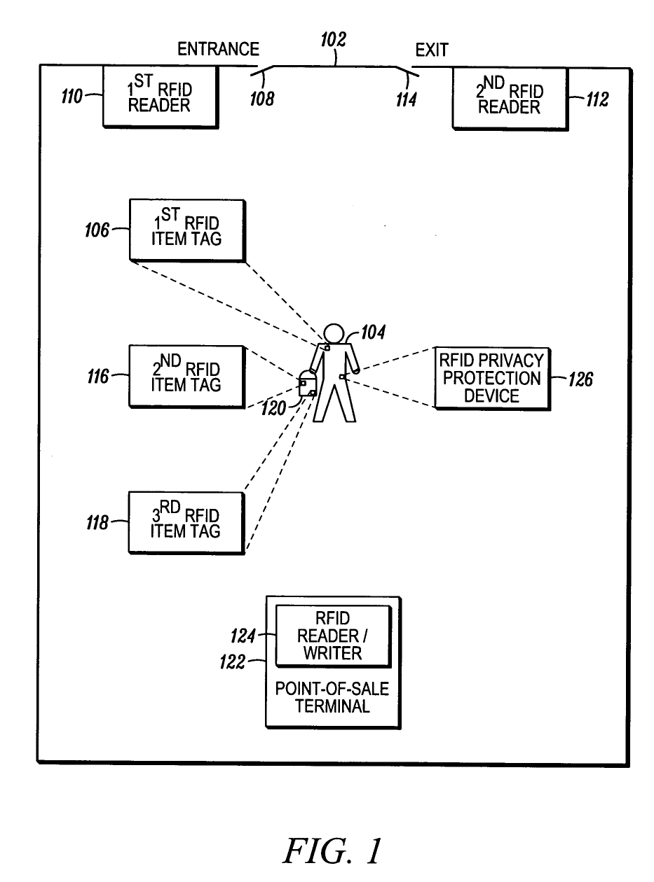

FIG. 1 is a block diagram of an RFID system 100 in accordance with some embodiments of the invention. As shown in FIG. 1, the system 100 is used in a store 102. The system 100 is alternatively used in other environments such as secure facilities. Mobile parts of the system 100 are used outside of the store 102 or secure facility.

A person (user) 104 shown in the store 102, may enter the store 102 already in possession of one or more RFID tags such as a first RFID tag 106. The first RFID tag 106 would typically be attached to some possession (not shown) that the first RFID 106 is meant to track. The person 104 enters through an entrance 108. A first RFID reader (or ‘scanner’) 110 is located adjacent to the entrance 108 so as to be able to scan RFID tags on items being carried in or out of the entrance 108. A second RFID reader 112 is located near an exit 114 of the store 102. The first RFID reader 110 and the second RFID reader 112 scan (interrogate) RFID tags in their vicinity to prevent unauthorized removal (theft) of store inventory that is tracked with RFID tags. A second RFID tag 116 and a third RFID tag 118 are attached to items (not shown) in possession of the person 104. The items are carried in a basket 120. A point-of-sale terminal 122 that includes a RFID reader/writer 124 is located in the store 102. The RFID tags 106, 116, 118 include identifying information (e.g., ID numbers) and are adapted to communicate the identifying information in response to interrogation signals received from the first RFID reader, 110, second RFID reader 112 or the RFID reader/writer 124.

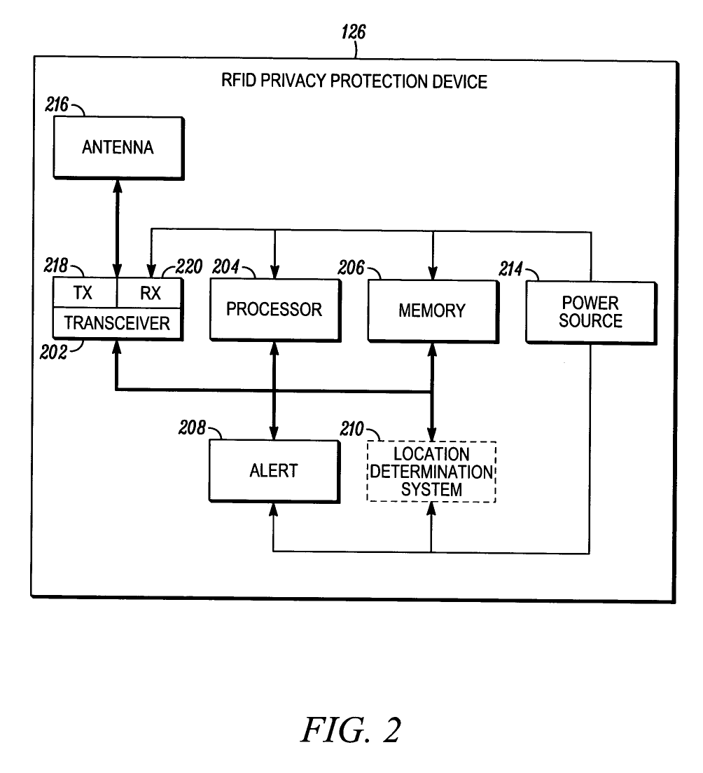

When the person 104 enters the store the first RFID reader 110 will scan the first RFID tag 106. The first RFID reader 110 and the second RFID reader 112 can be programmed to trigger an alert if any RFID tags are detected (to prevent theft through the entrance 108 and exit 114). In the case of the first RFID reader 110 located near the entrance 108, such programming would ordinarily be problematic if the first RFID tag 106 is active, because an alert would be triggered by the person 104 even though the item tracked by the first RFID tag 106 has not been stolen. The person 104 also has an RFID privacy protection device (RFID-PPD) 126. As described more fully below with reference to FIGS. 2-4 the RFID-PPD 126 prevents the first RFID reader 110 from reading the first RFID tag 106 thereby avoiding false alerts by the first RFID reader 110 and protecting the person's 104 privacy to the extent that ownership of the item tracked by the first RFID tag 104 is not divulged and/or the person's 104 movement can not be tracked by tracking the first RFID tag 104. In certain embodiments the first RFID reader 110 and the second RFID reader 112 are programmed to issue alerts only if RFID tags having ID numbers corresponding to items stocked by the store are detected. The system 100 does not require RFID tags to be rendered inactive at purchase. Thus, the RFID tags can be used for post purchase applications.

After finishing selecting items to be purchased, the person 104 brings the items to be purchased to the point-of-sale terminal 122. The point-of-sale terminal 122 uses the RFID reader/writer 124 to scan items possessed by the person 104, tallies up a total cost for the items that are possessed by the person 104 (but not already owned by the person 104, as in the case of the item tracked by the 1^{st} RFID reader) and after payment is received, alters the RFID tags attached to items being purchased to reflect a change in ownership to the person 104 (or more generally to a next level in a supply chain). The person 104 then proceeds to the exit 114. According to certain embodiments one or more of the RFID tags 106, 116, 118 are read-only tags and are not altered upon purchase.

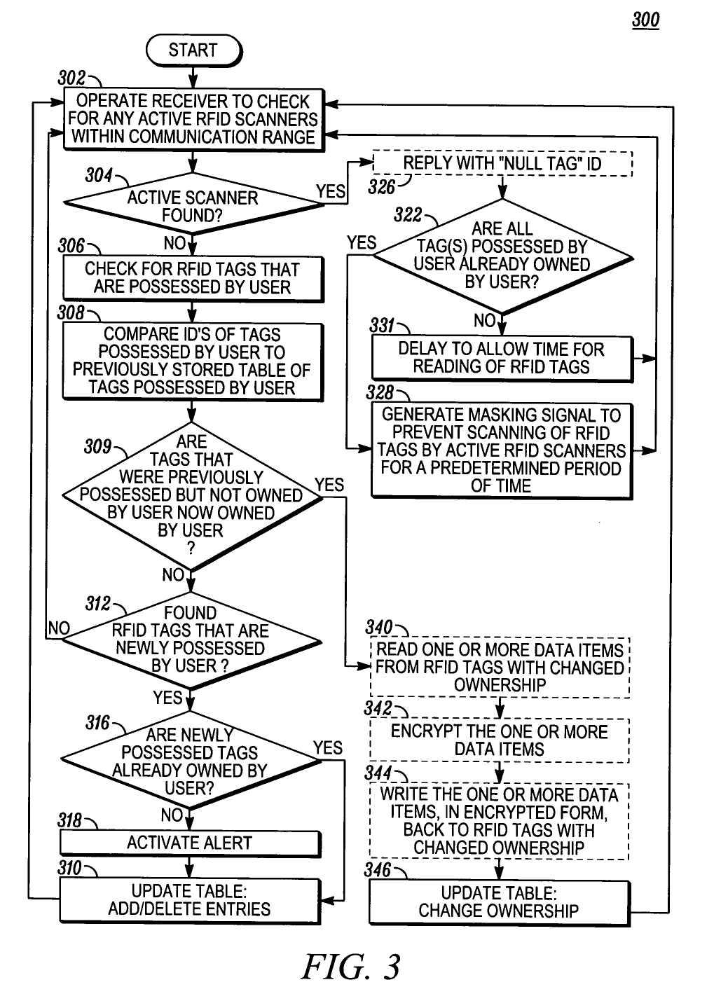

As more fully explained below with reference to FIGS. 2-3, if the person 104 does not take possession of any other items in the store 102 before exiting through the exit 114 (as in the case of browsing), the RFID-PPD 126 will prevent scanning of the first RFID tag 106 possessed by the person 104 by the second RFID reader 112 located at the exit 114. Thus, the person's 104 privacy will continue to be protected. If the person 104 tries to steal an item tracked by an RFID tag before leaving the store 102 the RFID-PPD 126 will not prevent scanning of RFID tags attached to the person's104 possessions allowing the person 104 to be apprehended.

FIG. 2 is a block diagram of the RFID-PPD 126 in accordance with some embodiments of the invention. The RFID-PPD 126 can be incorporated into another device, such as for example a cellular telephone (not shown). As shown in FIG. 2, the RFID-PPD 126 comprises a transceiver 202, processor 204, memory 206, alert 208 and optional location determination system 210 coupled together through a signal bus 212. The foregoing are supplied power by a power source 214. The transceiver 202 is coupled to an antenna 216. The transceiver 202 includes a transmitter 218 and a receiver 220. If the RFID-PPD is to support multiple RFID system that use different frequencies, multiple transceivers 202 and/or antennas 216 are optionally provided.

Having the power source 214 enables the RFID-PPD to have a larger communication range than passive RFID tags (e.g., 106, 116, 118) that derive power from received radio waves. Consequently as the person 104 moves around the RFID-PPD 126 will be able to establish communication with nearby RFID readers (e.g., 110, 112, 124) before the passive RFID tags 106, 116, 118 possessed by the person 104 are able to establish communication with nearby RFID readers. Designing the antenna 216 with a greater effective area than the effective area of antennas used in the passive RFID tags 106, 116, 118 used in the system 100 also helps the RFID-PPD 126 to establish communications with nearby RFID readers first. By way of nonlimitive example, the location determination system 210 can comprise a pedometer, a system that determines absolute position such as a GPS transceiver, or a system that determines relative position by detecting proximity to other wireless devices, or by measuring the distance from one or more other wireless devices (e.g., by triangulating position).

FIG. 3 is a flowchart of a method 300 of operating the RFID-PPD 126 shown in FIGS. 1, 2 in accordance with some embodiments of the invention. Although the method 300 shown in FIG. 3 is described below in the context of the RFID system 100 shown in FIG. I and the RFID-PPD 126 shown in FIG. 2, the method 300 can be used with RFID systems and RFID privacy protection devices that differ in design from what is shown in FIGS. 1-2. A program that executes the method 300 is suitably stored in the memory 206 and executed by the processor 204. The processor 204 programmed by the program that executes the method 300 serves as a controller of the RFID-PPD 126.

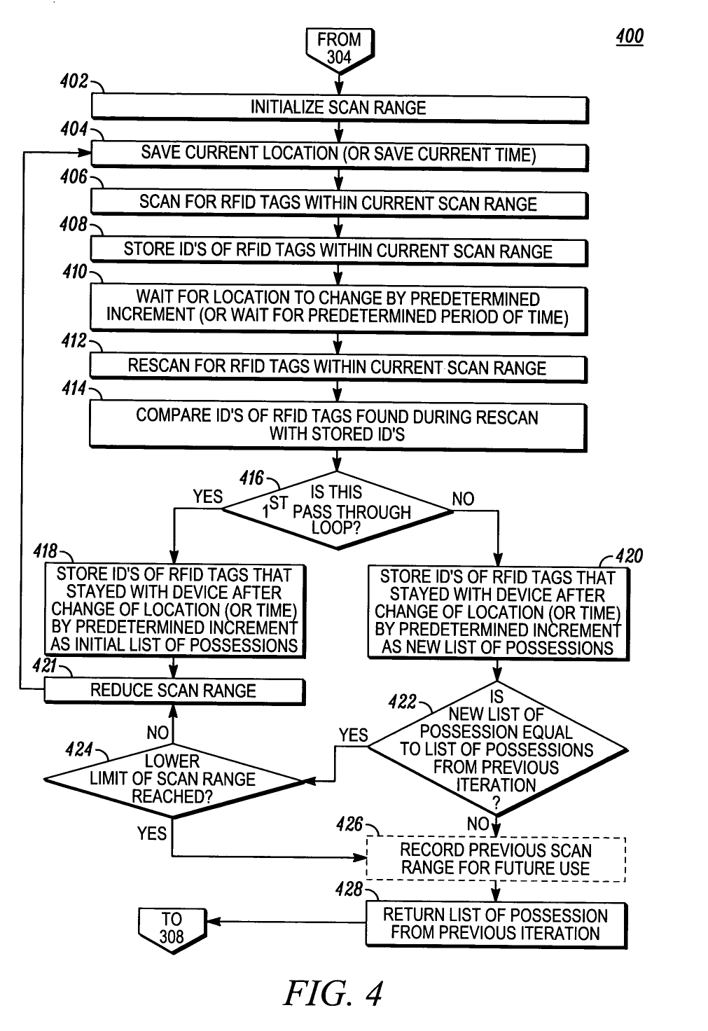

Referring to FIG. 3, in block 302 the receiver 220 of the RFID-PPD 126 is operated to check for any active RFID tag scanners (e.g. 110, 112, 124) within range of the RFID-PPD 126. As previously mentioned the RFID-PPD 126 is able to sense active RFID tag scanners at a greater range than the RFID tags 106, 116, 118. The outcome of decision block 304 depends on whether an active RFID tag scanner has been found. If the outcome of block 304 is negative the method continues with block 306. In block 306 the RFID-PPD checks for RFID tags that are possessed by the user. FIG. 4, described below focuses on details of a method of checking for RFID tags possessed by the user, according to certain embodiments of the invention. At a basic level, executing block 306 involves transmitting interrogation signals and listening for responses from RFID tags. In the process of checking for RFID tags possessed by the user, the RFID-PPD 126 receives ID numbers and optionally other information from the RFID tags possessed by the user. The other information can include information indicating the ownership of the possession, or information as to ownership may be included in ID numbers of the RFID tags.

In block 308 ID numbers of tags possessed by the user are compared to ID numbers in a table of tags possessed by the user that is stored in the RFID-PPD 126. The table, which is stored in binary form in the RFID-PPD 126 can be represented in readable form as shown in the following example:

TABLE I
RFID TAGS POSSESSED BY USER

| ID NUMBER | OWNED BY USER ? (Y/N) |
|---|---|
| 100 . . . 010 | Y |
| 101 . . . 110 | Y |
| 101 . . . 001 | Y |
| 110 . . . 011 | N |

In table I the first column gives the ID number and the second column indicates whether or not each RFID tag is owned by the user. Note that the ID number may include one or more bits that are used to indicate the ownership of the RFID tag. In the latter case the second column would be unnecessary. Information for the tags that are newly found in block 306 is suitably temporarily stored separately or marked as corresponding to newly found tags until the table is updated.

Block 309 is a decision block the outcome of which depends on whether RFID tags that were previously possessed by the user, but not owned by the user are now owned by the user. The determination made in block 309 is suitably made by comparing ownership information gathered in block 306 to information that had previously been stored in the RFID-PPD 126 in the table. If the outcome of block 309 is negative the method 300 branches to decision block 312.

The outcome of decision block 312 depends on whether any RFID tags that are newly possessed by the user have been found. If the outcome of block 312 is negative, then the method 300 returns to block 302. If the outcome of block 312 is positive then the method continues with decision block 316.

Decision block 316 depends on whether any newly possessed RFID tags are owned by the user. If there are newly possessed tags that are not owned by the user, then the method branches to block 318 in which the alert 208 is activated. The alert suitably takes the form of a visible alert (e.g., flashing light, displayed icon), an audible alert (e.g., a beep), and/or a tactile alert. If the user has knowingly obtained another possession then activation of the alert 208 in block 318 merely confirms that the RFID-PPD 126 has registered the new possession. If the user has not knowingly added another possession then activation of the alert in block 318 alerts the user that someone may be moving another RFID tag near the user in order to penetrate privacy protection provided RFID-PPD 126. This will be explained further below after other relevant aspects of the method 300 have been described. After activating the alert 208 in block 318 the method 300 proceeds to block 310.

In block 310 the table of tags possessed by the user is updated by adding information on newly discovered RFID tags and deleting entries for RFID tags that are no longer possessed by the user. According to certain embodiments, tags that are marked as owned by the user are not deleted even if they are temporarily not possessed by the user. If the outcome of block 316 is positive, the method proceeds directly to the block 310 without activating the alert 208.

If it is determined in block 309 that there are RFID tags possessed and owned by the user that were previously possessed by the user but not owned then the process 300 will branch to optional block 340. The foregoing positive outcome of block 309 occurs when a user purchases items and an authorized RFID writer (e.g., 124) changes the ownership of RFID tags. Actions in block 340 and subsequent blocks will describe further below after other aspects of the operation of the RFID-PPD 126 have been described.

In the process of executing block 302-318, as long as there is no active RFID scanner within range, the RFID-PPD device 126 will periodically update the table of RFID tags possessed by the user.

If there is an active RFID scanner within range, then the outcome of decision block 304 will be positive and the method 300 will branch to optional block 326. In block 326 the RFID-PPD 126 will reply to the active scanner by sending out a null ID. The null ID can be a fixed or varying (e.g., random ID) that the RFID-PPD 126 sends out in order to provide some response to active scanners. According to alternative embodiments a portion of the null ID is used to identify the RFID-PPD 126 as such to the scanner, and a portion is used to convey status information, such as whether or not the user has newly acquired RFID tags, and whether or not some of the newly acquired tags are not owned by the user. Alternatively, the RFID-PPD does not send out the null ID. After optional block 326 the method 300 proceeds to decision block 322.

The outcome of decision block 322 depends on whether all tags possessed by the user are owned by the user. This is suitably determined based on information stored in the RFID-PPD 126 in the table. If the outcome of block 322 is negative, the flowchart branches to delay block 331. Delay block 331 allows time for an external RFID reader (e.g., 110, 112, 124) to communicate with RFID tags possessed by the user. The delay 331 can be made an increasing function of the number tags possessed by the user such that sufficient time, plus some safety margin, is allowed for the RFID tags possessed by the user to be read. In normal use in the store 102 delay block 331 will be executed when the person 104 brings items to be purchased to the point-of-sale terminal 122. In this case the delay 331 allows time for the RFID reader/writer 124 to read RFID tags attached to the items being purchased and the ownership of the RFID tags to be changed by writing to the RFID tags. In the case that the user attempts to steal items and proceeds to the exit 114 without paying, block 331 will be reached when the user is at the exit 114, proximate the second RFID reader 112. The second RFID reader 112 will then detect that items that have not been checked out are being taken from the store 102. After the delay 331 the method loops back to block 302.

According to an alternative embodiment, rather than the RFID reader/writer 124 changing the ownership of the RFID tags possessed by the user, the RFID reader/writer 124 authorizes the RFID-PPD 126 to change the ownership of the RFID tags. According to another alternative embodiment, the RFID reader/writer 124 communicates the change of ownership of RFID tags (e.g., 116, 118) to the RFID-PPD 126 and the RFID 126 records the ownership for future use (e.g., in executing block 322)

If it is determined in block 322 that all tags possessed by the user are owned by the user the method 300 branches from block 322 to block 328.

In block 328 a masking signal is generated for a predetermined period of time. The masking signal serves to prevent the active scanner(s) detected in the most recent execution of block 302 from reading the RFID tags possessed by the user. In normal use of the RFID-PPD 126 in the store 102, block 328 is executed after the user has paid for items at the point-of-sale terminal 122 and is moving past the second RFID reader 112. Moreover, to protect the user's privacy, block 328 is executed after the user has left the store 102, if the user has not taken possession of additional RFID tags and moves within range of RFID readers outside of the store 102.

The masking signal generated in block 328 can be a signal of the type used by blocker tags. Blocker tags generate signals that simulate the presence of a very large number of RFID tags and thereby overwhelm the active RFID scanner(s). Alternatively, the masking signal can take the form of an unmodulated carrier signal or a noise signal, both of which convey no information. The masking signal can interfere with the reception of signals by the active RFID scanner, by the RFID tags or both. In embodiments in which masking signal is intended primarily to interfere with reception of signals by the RFID tags, the strength of the masking signal that is generated is suitably based on the range to the furthest RFID tag possessed by the user. The effective range to the furthest RFID tag possessed by the user can be inferred from the strength of the weakest signal received from an RFID tag possessed by the user, or from a scan range setting of the RFID-PPD 126 that is required to reach all of the RFID tags possessed by the user. The latter is determined in the method shown in FIG. 4, described below. In embodiments in which the masking signal is intended to interfere with reception of signals by the active RFID scanner, the strength of the masking signal is likewise based on the range to the active RFID scanner. By way of nonlimitive example, the predetermined period for which the masking signal is generated in block 328 can be 5 seconds. After generating the masking signal, the method will return to block 302 to determine if the user is still within range of the active RFID scanner, and if so return to block 328 and continue to generate the masking signal. Per blocks 322, 328 unless the user possesses a tag that the user does not own the masking signal will be generated to prevent scanning of the RFID tags possessed by the user. The RFID-PPD 126 prevents gratuitous scanning of RFID tags possessed by the user, and only allows scanning of the tags possessed by the user, if the user has taken possession of an RFID tag that the user does not own.

When block 322 is first reached after branching from block 304, if the outcome is negative meaning that the user does have newly possessed RFID tags that are not owned by the user, the masking signal will not be generated and the method 300 will branch through to a delay 331. Thus, the RFID-PPD 126 will allow scans of RFID tags possessed by the user, but not owned by the user. This allows the RFID system 100 to perform its intended function of scanning tags of items that the user takes possession of and preventing theft of such items.

In normal use, after the user has left the store 102, the user will be out of range of an active scanner for a period of time. Consequently, the outcome of block 304 will be negative and the method 300 will reach decision block 309. If it is determined in decision block 309 that tags that were previously possessed by the user are now owned by the user (e.g., having had their ownership changed by the RFID reader/writer 124) then the method 300 will branch from block 309 to optional block 340.

According to certain embodiments of the invention, certain data (e.g., article identifying information) that is stored in the RFID tags 106, 116, 118 can only be changed by a party at a particular level of a supply chain (using a device such as the RFID reader/writer 124 and the RFID-PPD 126) if the aforementioned data that indicates ownership has been changed to indicate ownership at the particular level of the supply chain (e.g., distributor, retailer end user).

In block 340 one or more data items are read from the newly owned RFID tags. According to an alternative embodiment, in lieu of block 340 information that was previously read from the newly owned RFID tags and stored in the memory 206 in the RFID-PPD 126 is read out from the memory 206. In optional block 342 the one or more data items are encrypted and in optional block 344 the one or more data items are written back to the RFID tags from which they were read in encrypted form. Encrypting data in RFID tags owned by the user adds another layer of privacy protection. Encrypting the data preempts attempts to breach the user's privacy protection by a form of attack in which a third party attacker moves another RFID tag with ownership not set to the user (for example with the ownership set to “retailer”) within range of the RFID-PPD 126. The RFID-PPD 126 would respond by not generating the masking signal when a scanner operated by the attacker attempts to scan RFID tags possessed by the user. Such an attack could be mounted in a public place, not necessarily in a store. However, if the content of tags owned by the user is encrypted the attacker will not be able to violate the privacy of the user. After block 344, the method returns proceeds to block 346 in which the table stored in the RFID-PPD 126 is updated to reflect the change in ownership. Thereafter, the method 300 returns to block 302 and continues as previously described. Additionally, as mentioned above the alert 208 is activated each time the RFID-PPD 126 determines that an RFID tag that is not owned by the user has been possessed by the user. Consequently if the above mentioned form of attack is attempted the user will be alerted to it by activation of the alert 208 in block 318. The user will thus be made aware that a third party (e.g., a criminal) is attempting to investigate the user's belongings. Alternatively, the alert is activated each time an RFID tags comes into possession of the user even if it is owned by the user.

FIG. 4 is a flowchart of a method 400 of compiling a list of RFID item tags possessed by a user that is used in block 306 of the method 300 shown in FIG. 3 according to certain embodiments of the invention. In block 402 a scan range is initialized. The scan range is set by setting a transmit power of the transmitter 218 and/or by setting a signal amplification level in the receiver 220. The scan range is suitably initialized to 2 to 3 meters. The actual scan range achieved may depend on the nature of obstructions between the RFID-PPD 126 and RFID tags to be scanned. In block 404 the current location, obtained from the location determination system 210 is saved in the memory 206. According to an alternative embodiment that does not rely on the location determination system 210 a current time reading is saved. In block 406 a scan for RFID tags is made with the current scan range. The scan comprises transmitting signals to trigger responses and receiving responses. In order to handle multiple responding RFID tags a singulation protocol is suitably used. In block 408 the ID's and optionally other data (e.g., ownership) of tags within the current scan range are stored in the memory 206. In block 410 the RFID-PPD 126 waits for its location to change by a predetermined increment. By way of example, a suitable value for the predetermined increment is between 0.5 meters and 10 meters. According to the aforementioned alternative embodiment, in block 410 the RFID-PPD waits for a predetermined period of time. In block 412 the RFID-PPD 126 rescans for RFID tags within the current scan range. In block 414 the ID's identified in block 412 are compared with the ID's stored in block 408.

Blocks 404 to block 424 are part of a loop that is repeated until a list of RFID tags possessed by the user is finalized. Decision block 416 depends on whether a current pass through the loop is the first pass through the loop. On the first pass through the loop, the method 400 will branch to block 418. In block 418 the ID's (and optionally other data) of RFID tags that stayed within the current scan range after the change in location by the predetermined increment (or after the predetermined period of time) will be stored in the memory 206 as an initial list of RFID tags. The RFID tags that have stayed within range are tentatively considered to be possessed by the user. After block 418, in block 421 the scan range is reduced. By way of example, the scan range is suitably reduced in increments of 0.5 meters or by a factor of 0.67, or according to some other predetermined schedule each time block 421 is executed. After block 421 the method 400 loops back to block 404 and proceeds as described above. If upon reaching block 416 it is determined that the current pass through the loop is not the first pass through the loop then the method 400 branches to block 420 in which the ID's of RFID tags that stayed with the RFID-PPD 126 from the latest execution of block 406 to the latest execution of block 412 are stored in the memory 206 as a new list of RFID tags possessed by the user. In decision block 422 the new list of RFID tags possessed by the user is compared to the list of RFID tags possessed by the user during an immediately preceding iteration of the loop (during which the scan range was larger). If the new list includes fewer RFID tags, meaning that the scan range was made too small, then the method branches to optional block 426 in which the scan range used in the immediately preceding iteration of the loop is stored in the memory 206 for future use. Thereafter, the method 400 continues to block 428 in which the list of RFID tags found in the immediately preceding iteration of the loop is returned for further use in the method 300 shown in FIG. 3. According to certain embodiments, the masking signal strength is based on the scan range recorded in block 426.

If it is determined in block 422 that the list of possessions obtained in the current iteration of the loop is the same as the list of possession obtained in the preceding iteration of the loop, meaning that the current scan range is sufficient, then the method 400 proceeds to decision block 424. The outcome of decision block 424 depends on whether a lower limit on the scan range has been reached. If the lower limit has been reached, then the method 400 branches to block 426. If the lower limit has not been reached, then the method 400 proceeds to block 421.

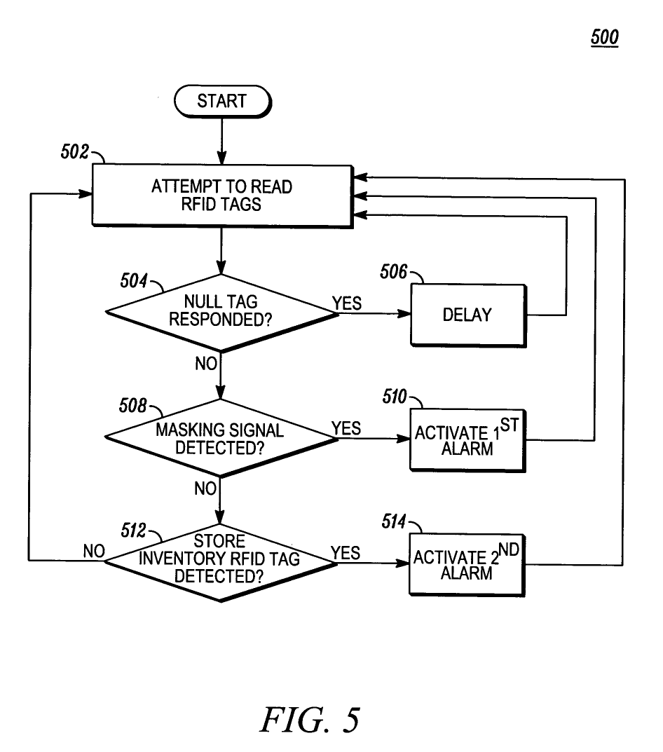

FIG. 5 is a flowchart of a method 500 of operating an RFID reader that is used in the RFID system 100 shown in FIG. 1 in accordance with some embodiments of the invention. The method 500 is suitably implemented by the first RFID scanner 110 located near the entrance 108 and the second RFID scanner 112 located near the exit 114. In block 502 the reader (e.g., 110, 112) attempts to read RFID tags. The reader will continue to attempt to read RFID tags until tags are detected. Block 504 is decision block, the outcome of which depends on whether a null tag ID, such as sent in block 326 has been read. According to the method 500, if a null tag ID is received, the null tag ID is taken as an indication that the RFID-PPD 126 is protecting the privacy of the user and will be generating a masking signal to protect the privacy of the user. Accordingly, the RFID scanner will not be able insure the security of items tracked by RFID tags possessed by the user. However, receipt of the null tag ID indicates to the reader that the masking signal is being generated by the RFID-PPD 126 and not by an unauthorized masking signal generator. If the null tag ID is received the method will return to attempting to read RFID tags after a delay 506. If a null tag ID is not received, then the method 500 branches to decision block 508. The outcome of decision block 508 depends on whether a masking signal has been detected. If a masking signal is detected then in block 510 a first alarm is activated in block 510. The first alarm 510 indicates that an unauthorized masking signal has been detected. If a masking signal is not detected, then the method continues with decision block 512, the outcome of which depends on whether one or more RFID tags of store inventory have been detected. (In other applications the RFID tags are attached to other items to be secured). If an RFID tag used to track store inventory has been detected then in block 514 a second alarm is activated. The second alarm indicates that an unauthorized removal (e.g., theft) of items tracked by RFID tags is occurring. In the case that no RFID tags are detected in block 512, the method 500 returns to block 502 to continue scanning for RFID tags. Also, after the first alarm or the second alarm are sounded in blocks 510, 514, the method 500 returns to block 502 t continue scanning for RFID tags. The alarms can be visible (e.g. a flashing light), audible (e.g., a siren) or silent (e.g., a discreet message to security personnel). Rather than providing two distinct alarms a single alarm can be used in both of the abovementioned circumstances. According to an alternative embodiment, rather than simply sending the null ID from the RFID-PPD 126 to a RFID reader, cryptographic methods are used to authenticate the RFID-PPD 126 to RFID readers.

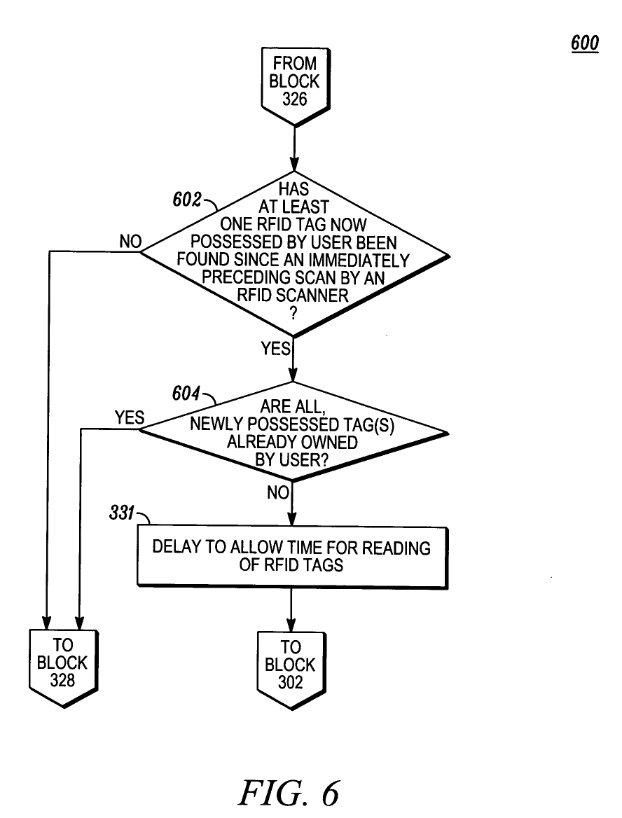

FIG. 6 is a flowchart fragment 600 showing one alternative to the method shown in FIG. 3. Per FIG. 6, the criteria for deciding whether or not to generate the masking signal that is expressed in block 322 is replaced with blocks 602, 604. The outcome of decision block 602, which follows optional block 326 in FIG. 3, depends on whether at least one RFID tag currently possessed by the user has been added since RFID tags possessed by the user were scanned by a RFID reader. In order to execute block 602, information as to which RFID tags have been scanned by RFID readers is stored in the RFID-PPD 126. If the outcome of block 602 is negative the flowchart fragment 600 branches to block 328 of FIG. 3 in which the masking signal is generated. If the outcome of block 602 is positive the flowchart fragment 600 branches to decision block 604. Decision block 604 provides another basis for generating the masking signal and protecting the user's privacy. Decision block 604 test if all of the newly possessed RFID-tags are already owned by the user. In use, when a user is at home preparing to leave, the user may take possession of items with RFID tags, that the user already owns. In this case, external scanners should not be allowed to read the RFID tags unnecessarily. Accordingly, if the outcome of block 604 is positive, the flowchart fragment 600 branches to block 328 of FIG. 3. If the outcome of block 604 is negative, the flowchart fragment 600 branches to block 331 and then continues to block 302 of FIG. 3.

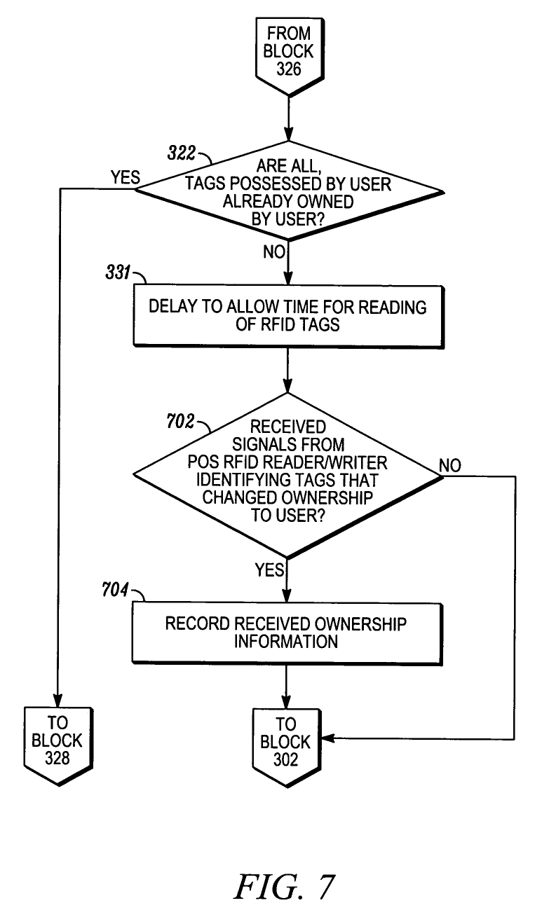

FIG. 7 is a flowchart fragment 700 showing another alternative to the method shown in FIG. 3. According to the flowchart fragment shown in FIG. 7 after the delay 331 to allow the active scanner to read the RFID tags possessed by the user, the flowchart fragment 700 branches to decision block 702. The outcome of decision block 702 depends on whether the RFID-PPD receives signals from a point-of-sale RFID reader/writer identifying RFID tags that changed ownership to the user. If the outcome of block 702 is positive then in block 704 information based on the change in ownership is stored in the RFID-PPD 126. If the outcome of block 702 is negative, the flowchart fragment 700 branches to block 302 in FIG. 3. The alterative shown in FIG. 7 can be used with read-only RFID tags because it does not rely on ownership state information read from the RFID tags.

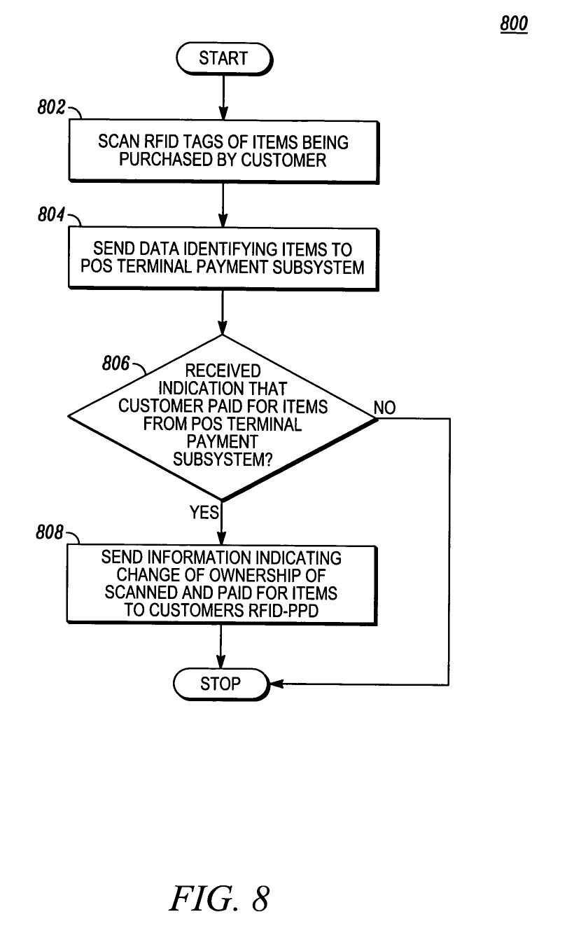

FIG. 8 is a flowchart showing a method 800 of operating the RFID reader/writer 124 of the RFID system 100 shown in FIG. 1. The method 800 shown in FIG. 8 complements the modification of the method 300 shown in FIG. 7. According to the alternative shown in FIG. 8 the RFID reader/writer 124 writes ownership state information to the RFID-PPD 126 (not to the RFID tags 116, 118). In block 802 the RFID reader/writer 124 scans RFID tags attached to items being purchased by the user. In block 804 the RFID reader/writer 124 sends data identifying items being purchased to a payment subsystem (not shown) of the point-of-sale terminal 122. Decision block 806 depends on whether an indication that the user paid for the scanned items is received from the payment subsystem. If so, in block 808 information indicating change of ownership of the scanned and paid-for items is sent to the user's RFID-PPD 126. If for some reason, the indication of payment is not received, block 808 is bypassed. The information sent in block 808 can for example take the form of a list of RFID tag numbers preceded by a preamble indicating the nature of the list. Although not shown in FIG. 8, steps for detecting a masking signal and activating an alarm if the masking signal is not preceded by a null tag ID can be included in the method 800.

According to an alternative embodiment the ownership state of RFID tags possessed by the user is determined by the RFID-PPD 126 itself based on the duration of possession and/or the distance that possessed items have been transported by the user. One example is to record that RFID tags are owned by the user if the user has possession after a certain time interval has elapsed since the user took possession of the RFID tags. The time period should not be so short that an unscrupulous user could take possession of an item and linger in the store 102 until the time interval has elapsed. Another example is to record that RFID tags possessed by the user are owned by the user if the user has possession of the RFID tags after moving a predetermined distance since taking possession. The distance should be larger than a large store. Optionally, the foregoing criteria for ownership can are combined with each other and/or combined with the requirement that the each possessed by the user must be scanned at least once before it is recorded in the RFID-PPD 126 as owned by the user. The foregoing criteria can be combined in an ownership decision function that combines the criteria by weighted sums, and or Boolean operators (e.g., AND, OR) or other heuristic rules. The foregoing criteria are suitable for protecting the user's privacy from attack via read-only tags, if there is no RFID infrastructure support for the RFID-PPD 126.

The RFID-PPD 126 works harmoniously with other parts of the RFID system 100 protecting the privacy of the user without compromising the ability of the RFID system 100 to perform its intended security function.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. An apparatus for protecting a user from privacy invasion via RFID tags, the apparatus comprising:
a controller; and
at least one transceiver coupled to the controller,
wherein the at least one transceiver has sufficient sensitivity to detect a scan signal from a RFID reader before one or more RFID devices possessed by the user can detect the scan signal, and
wherein the controller is adapted to control the at least one transceiver to detect the one or more RFID devices possessed by the user and to selectively generate a masking signal in response to detection of the scan signal, wherein said masking signal prevents scanning of said one or more RFID devices by said first RFID device.

2. The apparatus according to claim 1 wherein the controller is adapted to control the at least one transceiver to generate the masking signal only if all of the one or more RFID devices are owned by the user.

3. The apparatus according to claim 1 wherein the controller is adapted to determine a weakest signal level received from the one or more RFID devices possessed by the user, and to adjust a transmit power level based on the weakest signal level.

4. The apparatus according to claim 1 wherein the controller is adapted to check for nearby RFID readers before detecting said one or more RFID devices possessed by the user.

5. The apparatus according to claim 1 wherein said controller is adapted to add RFID devices to a possession list only if said RFID devices stay with said user for a prescribed period of time.

6. The apparatus according to claim 1 wherein said controller is adapted to add RFID devices to a possession list only if said RFID devices stay with said user as said user moves.

7. An apparatus for protecting a user from privacy invasion via RFID tags, the apparatus comprising:
a controller; and
at least one transceiver coupled to the controller,
wherein the controller is adapted to control the at least one transceiver to read one or more RFID devices possessed by the user and to selectively generate a masking signal in response to detection of an RFID reader scan signal if all of the one or more RFID devices possessed by the user are owned by the user, wherein said masking signal prevents scanning of said one or more RFID devices owned by the user by said RFID reader.

8. An RFID system comprising:
a plurality of RFID item tags each of which includes identifying information, wherein each of said plurality of RFID item tags is adapted to communicate said identifying information;
one or more RFID readers adapted to interrogate said plurality of RFID item tags and receive said identifying information; and
an RFID privacy protection device adapted to communicate with a set of RFID items tags possessed by a user and to determine ownership of at least a subset of said set of RFID item tags, and to generate a masking signal to prevent communication of said identifying information of said set of RFID items, if each of said set of RFID item tags is owned by said user.

9. The RFID system according to claim 8 wherein:
ownership state information is stored in said subset of said set of RFID item tags; and
said RFID privacy protection device is adapted to determine ownership by reading said set of RFID item tags.

10. The RFID system according to claim 8 wherein:
said RFID privacy protection device is adapted to determine ownership of each of said set of RFID tags based, at least in part, one or more periods for which each of said set of RFID tags have been possessed by said user.

11. The RFID system according to claim 8 wherein:
said RFID privacy protection device is adapted to determine ownership of each of said set of RFID tags based, at least in part, a distance of movement of each said set of RFID tags in possession of said user.

12. The RFID system according to claim 8 wherein said RFID privacy protection device is adapted to respond to alteration of ownership of said subset of said set of RFID item tags by reading one or more information items, encrypting said one or more information items, and writing said one or more information items, in encrypted form, back to said subset of said set of RFID item tags.

13. The RFID system according to claim 8 wherein
ownership state information for said subset of said set of RFID item tags is stored in said RFID privacy protection device; and
said RFID system further comprises a point of sale RFID writer adapted to communicate alterations of said ownership state information of said subset of said set of RFID item tags to said RFID privacy protection device when said subset of said set of RFID items tags are attached to items being purchased by said user.

14. The RFID system according to claim 8 wherein said RFID privacy protection device is adapted to check for active RFID readers and only communicate with said plurality of RFID item tags if there are no active readers within range.

15. The RFID system according to claim 8 wherein said RFID privacy protection device is adapted to require that each RFID item tag included in said set stay within a predetermined range of said RFID protection device that is determined by a predetermined interrogation signal strength, for a predetermined period of time.

16. The RFID system according to claim 8 wherein said RFID privacy protection device includes a location determination system, wherein said RFID privacy protection device is adapted to require that each RFID item tag included in said set stay within a predetermined range of said RFID protection device that is determined by a predetermined interrogation signal strength after a movement of said RFID privacy protection device of a predetermined measure, as determined by said location determination system.

17. The RFID system according to claim 8 wherein said RFID privacy protection device further comprises an alert and wherein said RFID privacy protection device is adapted to activate said alert when a new RFID item tag is added to said set.

18. A method of operating an RFID privacy protection device, the method comprising:
checking for a first active RFID reader;
in the case that the first active RFID reader is found:
if all of the one or more RFID item tags possessed by the user are owned by the user, generating a masking signal to prevent scanning of RFID item tags possessed by the user by the first active RFID reader.

19. The method of operating the RFID privacy protection device according to claim 18 wherein:
in the case that no active RFID reader is found:
checking for one or more RFID item tags that are possessed by a user; and
if one or more RFID item tags that are possessed by the user are found, determining the ownership of the one or more RFID item tags possessed by the user.

20. The method of operating the RFID privacy protection device according to claim 19 wherein checking for one or more RFID item tags that are possessed by the user comprises:
checking if one or more detected RFID items stays with the user for a predetermined period of time.

21. The method of operating the RFID privacy protection device according to claim 19 wherein checking for one or more RFID item tags that are possessed by the user comprises:
checking if one or more detected RFID items stays with the user through a predetermined movement.

22. The method of operating the RFID privacy protection device according to claim 19 further comprising:
updating information in the RFID privacy protection device to reflect that the one or more RFID item tags that are possessed have been found.

23. The method of operating the RFID privacy protection device according to claim 19 wherein determining the ownership of the one or more RFID item tags possessed by the user comprises:
checking information stored in the RFID privacy protection device.

24. The method of operating the RFID privacy protection device according to claim 19 further comprising:
if one or more RFID item tags that are newly possessed by the user are found:
activating an alert to alert the user.

25. The method of operating the RFID privacy protection device according to claim 19 further comprising:
in the case that the first active RFID reader is found and if one or more RFID item tags possessed by the user are not owned by the user:
after a delay, receiving new information indicative of ownership of the one or more RFID item tags possessed by the user that were not previously owned by the user.

26. The method of operating the RFID privacy protection device according to claim 25 wherein receiving new information indicative of ownership of the one or more RFID item tags possessed by the user that were not previously owned by the user comprises:
receiving information from an RFID writer.

27. The method of operating the RFID privacy protection device according to claim 25 wherein receiving new information indicative of ownership of the one or more RFID item tags possessed by the user that were not previously owned by the user comprises:
receiving information from the one or more RFID item tags possessed by the user that were not owned by the user.

28. The method of operating the RFID privacy protection device according to claim 25 further comprising:
reading one or more data items;
encrypting the one or more data items; and
writing the one or more data items, in encrypted form, back to the RFID item tags possessed by the user that were not previously owned by the user.
